(19) United States
(12) Patent Application Publication
(10) Pub. No.: US 2014/0278698 A1
(43) Pub. Date: Sep. 18, 2014

(54) INTEGRATED PROJECT PLANNING

(71) Applicants: Revati Anna ELDHO, Bangalore (IN); Sadaf SHAKIL, Bangalore (IN); Seema SACHDEVA, Bangalore (IN); Jonathan RHODES, London (GB)

(72) Inventors: Revati Anna ELDHO, Bangalore (IN); Sadaf SHAKIL, Bangalore (IN); Seema SACHDEVA, Bangalore (IN); Jonathan RHODES, London (GB)

(21) Appl. No.: 13/840,082

(22) Filed: Mar. 15, 2013

(51) Int. Cl. G06Q 10/06

(52) U.S. Cl. CPC G06Q 10/06313
USPC 705/7.23

(57) ABSTRACT

Various embodiments of systems and methods for generating planning values of a project are described herein. An integrated project planning framework is provided to generate planning values of the project. The integrate project planning framework include a valuation options module that provides several planning value generation options. The valuation options module includes planning value generation modules to generate planning values related to different organizational functions. The valuation options module also includes a plan specific valuation module that includes some of the planning value generation modules to generate planning values of a project. A valuation triggering module may identify the plan specific valuation module to be executed for generating the one or more planning values of the project. The planning value generation modules, included in the plan specific valuation module, are executed to generate the one or more planning values of the project.

### FIELD

Embodiments generally relate to computer systems, and more particularly to methods and systems for generating planning values of a project.

### BACKGROUND

Financial planning of a project may involve determining various plan values such as cost, revenue, etc., related to the project. Different pricing techniques are available to determine the plan values of the project. Each of these pricing techniques is defined to determine plan values for a particular organizational function. For example, a sales and distribution pricing technique may be defined to determine plan values related to sales and distribution function, and a material management based pricing technique may be defined to determine plan values related to material management.

At present, a planning system can use only one of these pricing techniques, at a time, for planning a project. Due to this, the present planning system cannot be used when the planning requires plan values related to different organizational functions.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram illustrating an integrated project planning framework, according to an embodiment.

FIG. 2 is a detailed block diagram illustrating an integrated project planning framework, according to an embodiment.

FIG. 3 is a flow diagram illustrating a method for generating planning values of a project, according to an embodiment.

FIG. 4 is an exemplary block diagram illustrating a plan specific valuation module, according to an embodiment.

FIG. 5 is an exemplary output map for the plan specific valuation module 400 of FIG. 4, according to an embodiment.

FIG. 6 is a block diagram illustrating a planning application displaying the planning values generated by the plan specific valuation module of FIG. 4, according to an embodiment.

FIG. 7 is a block diagram illustrating a computing environment in which the techniques described for generating planning values of a project can be implemented, according to an embodiment.

### DETAILED DESCRIPTION

Embodiments of techniques for generating planning values of a project are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment. Thus, the appearances of these phrases in various places throughout this specification are not necessarily all referring to the same embodiment. Furthermore, the particular features, structures, or characteristics may be combined in any suitable manner in one or more embodiments.

FIG. 1 is a block diagram illustrating an integrated project planning framework 100, according to an embodiment. The integrated project planning framework may be used to determine plan values for a project. In one embodiment, a project is a task to achieve a particular goal. Project planning includes determining planning values, for several planning parameters, which may be required to execute the project. For example, consider a project to construct a building. The “building construction” project may be planned by determining planning values for a “resource type” planning parameter, a “resource” planning parameter, and a “quantity” planning parameter that are required for executing the building construction project. In one embodiment, the planning values for some of the planning parameters may be provided by a user. In the above example, a user may provide the planning values for the “resource type” planning parameter as “activity resource type” and “material resource type”. Similarly, the user may provide “building architect” planning value for the “resource” planning parameter corresponding to “activity resource type”, and “construction bricks” planning value for the “resource” planning parameter corresponding to “material resource type”.

The planning values for the other planning parameters, in the project, may be generated automatically by a valuation process. Valuation is a process to automatically generate planning values corresponding to planning parameters in a project. A valuation options module 102, in the integrated project planning framework 100, includes several planning value generation modules 104, 106, and 108 that may be used to automatically generate planning values for a particular planning parameter. In on embodiment, the different planning value generation modules 104, 106, and 108 are defined to determine planning values related to different organizational functions. Organizational functions may include different activities performed in a firm, for example, marketing, sales and distribution, human resources, etc. In the valuation options module 102, for example, the planning value generation module 104 may be defined to generate planning values related to human resources organizational function, the planning value generation module 106 may be defined to generate planning values related to sales and distribution, and the planning value generation module 108 may be defined to generate planning values related to marketing organizational function.

In one embodiment, the planning value generation modules 104, 106, and 108 may be executed based on the organizational function related to the planning values, which is to be generated. In the above example, a valuation process may be executed to determine planning values for the “quantity” planning parameter. The planning values to be determined are the quantity (“number of working hours”) for “building architect” and the quantity of “building material” required for the “building construction” project. A “human resource” planning value generation module may be executed to determine planning values (“number of working hours”) for quantity of “building architect” that is related to “human resources” organizational function, and a “material management” planning value generation module may be executed to generate planning values for quantity of “building material” that is related to “material management” organizational function.

In one embodiment, the integrated project planning framework 100 includes a planning application 110 that includes planning value fields for receiving planning values of different planning parameters related to the project. The planning application 110 may receive the planning values, for some of the planning parameters, manually from a user. Similarly, the planning application may also receive a valuation request to determine planning values for some of the planning parameters. Based on the valuation request, the planning value generation modules 104, 106, and 108 in the valuation options module 102 may be executed to generate the planning values for the project. The generated planning values may then be populated in the planning application 110. The project planning framework 100 may therefore allow a user to easily generate and view planning values relate to different organizational function.

FIG. 2 is a detailed block diagram illustrating an integrated project planning framework 200, according to an embodiment. The project planning framework 200 includes a valuation options module 202 that provides different valuations options for automatically determining planning values related to a project. The valuation options module 202 includes several planning value generation modules 204, 206, 208, and 210 that are defined to generate planning values related to different planning parameters. The planning value generation modules 204, 206, 208, and 210 may be defined to generate planning values of planning parameters related to a particular organizational function. For example, one of the planning value generation modules 204, 206, 208, and 210 may be defined to generate planning values related to human resource organizational function, another of the planning value generation modules 204, 206, 208, and 210 may be defined to generate planning values related to sales and distribution, etc. In one embodiment, several planning value generation modules may be defined to generate planning values related to a particular organizational function. For example, a first group of planning value generation modules may be defined to generate planning values related to human resource organizational function, and a second group of planning value generation modules may be defined to generate planning values related to sales and distribution.

In one embodiment, the planning value generation modules 204, 206, 208, and 210 include a planning value generation logic 212, 214, 216, and 218, respectively, which defines the processing for generation of planning values. The planning value generation logic 212, 214, 216, and 218 may include several methods, which are to be executed, for generation of the planning values. For example, consider a planning value generation module that generates different planning values related to sales and distribution. In this case, planning value generation logic, included in the planning value generation module, may define processing for generating “sales” value, “profit” value, and other values related to sales and distribution.

In one embodiment, the planning value generation logic 212, 214, 216, and 218 may include pricing technique defined for different Enterprise Resource Planning (ERP) modules. An ERP module may define processes for the particular organizational function. For example, an ERP system may include an ERP module for “sales and distribution”, and another ERP module for “product planning”, etc. The different ERP modules have different pricing techniques that define the method to generate plan values corresponding to a particular organizational function. A pricing technique defines the logic for generating plan values related to a particular organizational function. For example, the pricing technique in a sales and distribution ERP module may define the logic for determining planning values related to sales and distribution. A user may modify the pricing technique of an ERP module and the modified pricing technique may then be included in the planning value generation logic 212, 214, 216, and 218.

In one embodiment, the planning value generation logic 212, 214, 216, and 218 processes the input data values, of input data parameters, to generate the planning values of the project. For example, planning value generation logic may defined to generate “price” planning value based on input data values of “customer”, “product ordered”, and “order quantity” input data parameters. In one embodiment, the planning value generation module 204, 206, 208, and 210 include an input parameters map 220, 222, 224, and 226, respectively, to map the input planning parameters with an input data source. The input data source provides input data values to the planning value generation logic 212, 214, 216, and 218 for generating the plan values. An input data source may include, for example, a project planning value field in the planning application 228. The planning value received at the planning value fields, of the planning application, may be provided as input data value to the planning value generation logic. In this case, the input parameters map may include the planning value field and the input parameters, corresponding to the planning value field, to receive the input data for the planning value field. For example, the planning value fields of the planning application 228 may receive planning values for the “customer”, “product ordered”, and “order quantity” planning parameters that may be provided as input data value for generating the “price” planning value. The input parameters map 220, 222, 224, and 226 may also map the input data parameters to a fixed value. For example, the input parameters may map a “tax” input data parameter to a fixed tax value based on the applicable fixed tax for a particular US state. The input planning parameter may also be mapped to another application that is used to define the project. In the above example, a web application may be used to define that a project has to be planned for a building construction. The web application may also be used to define that the building construction project has to be made in a particular location and should be completed within a particular time period. In this case, the information received in the web application may be mapped to the input planning parameter.

In one embodiment, an input data retrieval rule 230 and 232 may be assigned to some of the planning value generation modules 204 and 208. An input data retrieval rule 230 and 232 may define the rules for retrieving input data values from the input data sources. For example, an input data retrieval rule may define that the input data is to be retrieved from the input data sources whenever the input data values change. In one embodiment, the input data retrieval rule 230 and 232 includes a date rule that specifies the date on which the input data values are to be retrieved from the input data sources. In this case, the input data values may be retrieved on the specified date and the retrieved input data values may then be processed by one of the planning value generation logic 212, 214, 216, and 218 generating the planning values.

In one embodiment, the planning value generation modules 204, 206, 208, and 210 include output parameters to store the generated planning value. For example, the planning value generation module may include a “price” output parameter to store the generated “price” planning value. In one embodiment, the valuation options module 202 may also include a user defined planning value generation module 210 to generate the planning values of a project. The planning value generation module 210 may include a user defined planning value generation module 218, defined by a user, to generate planning values. For example, the user may define an equation, as the user defined planning logic, for generating planning values based on the equation. The user defined planning value generation module 210 may also include the input parameters map 226 to map the input data parameters for the user defined planning value generation logic 218 with any of the input data sources.

In one embodiment, the valuation options module 202 includes a plan specific valuation module 234 and 236 to generate planning values for a particular planning condition. In one embodiment, the planning condition may include a combination of planning scenario and a resource type. A planning scenario defines one or more conditions for a particular business. For example, a human resource planning scenario planning scenario may define that a non-US citizen should not be considered for a job posting in US. In the above example for the “building construction” project, the planning scenario for the project is “engineering, construction, and operations” and the resource types are “activity resource type” and “material resource type”. Based on the two combinations of the planning scenario and the resource type, two plan specific valuation modules “activity resource type” valuation module and a “material resource type” valuation module may be used to generate the planning values for the “building construction” project.

The plan specific valuation modules 234 and 236 may include planning value generation modules 204 and 206, and 208 and 210, respectively to generate planning values for the particular planning condition. The “activity resource type” plan specific valuation module may include planning value generation modules to generate plan values (“number of working hours”) when the resource type is “activity resource type”. The “material resource type” plan specific valuation module may include planning value generation modules to generate plan values (“number of building bricks”) when the resource type is “material resource type”. In one embodiment, the plan specific valuation modules 234 and 236 may include planning value generation modules 204 and 206, and 208 and 210, respectively to generate planning values for a particular organizational function. For example, one of the plan specific valuation modules 234 and 236 may include planning value generation modules to generate plan values related to a human resource organizational function, another of the planning value generation modules 234 and 236 may include planning value generation module to generate plan values related to personnel management organizational function.

In one embodiment, a mapping of the planning condition and the corresponding plan specific valuation module 234 and 236 may be stored in a valuation module selection table 238. In the above example, the valuation module selection table 238 may include two entries. A first entry may include a mapping of the combination (“engineering, construction, and operation” planning scenario and “activity resource type”) and the corresponding “activity resource type” valuation module. The second entry may include a mapping of the combination (“engineering, construction, and operation” planning scenario and “material resource type”) and the corresponding “material resource type” plan specific valuation module.

In one embodiment, the plan specific valuation module 234 and 236 may also include an execution sequence 240 and 242, respectively, defining the sequence in which the planning value generation modules 204 and 206, 208 and 210, respectively, are to be executed. Further, the plan specific valuation module 234 and 236 may also include an output parameters map 244 and 246, respectively, to map the output parameters of the planning value generation modules, 204 and 206, and 208 and 210, respectively, with a planning value field in the planning application 228. Based on the mapping, the generated planning values stored in the output parameters are transferred to the planning parameters field in the planning application 228. In the above example, the output values for the different planning parameters may be mapped to one of the planning value fields in the planning application.

In one embodiment, the integrated project planning framework 200 includes a planning application 228 that includes several planning value fields. The planning value fields display the planning values, corresponding to different planning parameters, for the project. In one embodiment, a valuation request to determine the planning values is received at the planning application 228. In one embodiment, the planning application 228 forwards the valuation request to a valuation triggering module 248 included in the integrated project planning framework 200. The valuation triggering module 248 may then search the valuation module selection table 238 to identify the plan specific valuation modules to be executed for generating the planning values of the project. The valuation triggering module 238 may identify the plan specific valuation modules based on the planning condition of the project. The valuation options module 202 may then execute the identified planning value generation modules in the valuation options module 202 to generate the planning values of the project. Based on the output parameters map 244 and 246 the generated planning values are updated to the planning value fields in the planning application 228.

FIG. 3 is a flow diagram illustrating a method 300 for generating planning values of a project, according to an embodiment. Initially, at block 302, a valuation request is received at a planning application to generate planning values for a project. In one embodiment, the valuation request is received to generate planning values related to different organizational functions. For example, consider a “car building” project that includes designing the car and then building the car. A user may provide the resource type planning values, “activity resource type” and “material resource type”, required for the car building project. The user may also provide the resource planning values, “car designer” and car building material “iron”, “aluminum”, and “plastic”, required for building the project. The valuation request may be received to determine the quantity of “man hours” of the car designer required to design the car, and the quantity of building material required for building the car.

Next at block 304 a plan specific valuation module is selected for determining the planning values of the project. The plan specific valuation module may be selected based on the planning conditions related to the project. In one embodiment, different plan specific valuation modules may be selected to generate planning values related to different organizational function. A valuation triggering module selects the plan specific valuation modules from a valuation module selection table, based on the planning conditions related to the project. In the above example, the planning conditions may include the planning scenario “engineering, construction, and operations” of the project, and the different planning resources “activity resource type” and “material resource type’ of the project. Based on the planning conditions, two plan specific valuation modules, “activity resource type” valuation module and “material resource type” valuation module may be selected. The “activity resource type” valuation module is selected to generate planning values (“number of man hours”) related to human resources organizational function and the “material resource type” valuation module is selected to generate planning values (“quantity of building materials”) related to material management organizational function.

Next at block 306 the plan specific valuation modules, selected at block 304, are executed. In one embodiment, executing the plan specific valuation modules includes executing the planning value generation modules included in the selected plan specific valuation modules. Finally at block 308 the planning values are generated based on the selected plan values executed at block 306. In the above example, the “activity resource type” valuation module and the “quantity of building materials” is executed to generate the “number of man hours” planning value and the “quantity of building materials” planning value. The generated planning values are populated in the planning application.

FIG. 4 is an exemplary block diagram illustrating a plan specific valuation module 400, according to an embodiment. The plan specific valuation module 400 may be defined to generate planning values for a particular planning condition. The plan specific valuation module 400 includes four plan value generation modules 402 for generating the planning values. The plan specific valuation module 400 also include the sequence 404 of execution for the plan value generation modules 402. A date rule 406 for retrieving input data values for one of the planning value generation modules 402 is also provided.

FIG. 5 is an exemplary output map 500 for the plan specific valuation module 400 of FIG. 4, according to an embodiment. The output map 500 includes an output parameter 502 that store the planning values generated by each of the plan value generation modules 402. The output map 500 includes a mapping of the output parameter 502 that stores planning values and the planning value fields 504, of a planning application, which are to be populated with the planning values. A description 506 of the planning value fields 504 is also provided.

FIG. 6 is a block diagram illustrating a planning application 600 displaying the planning values generated by the plan specific valuation module 400 of FIG. 4, according to an embodiment. Based on the output map, the planning value fields of the planning application 600 is populated with planning values generated by the plan value generation modules 402 of FIG. 4.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

FIG. 7 is a block diagram of an exemplary computer system 700. The computer system 700 includes a processor 705 that executes software instructions or code stored on a computer readable storage medium 755 to perform the above-illustrated methods. The processor 705 can include a plurality of cores. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. According to some embodiments, such as some in-memory computing system embodiments, the RAM 715 can have sufficient storage capacity to store much of the data required for processing in the RAM 715 instead of in the storage 710. In some embodiments, all of the data required for processing may be stored in the RAM 715. The stored instructions may be further compiled to generate other representations of the instructions and dynamically stored in the RAM 715. The processor 705 reads instructions from the RAM 715 and performs actions as instructed. According to one embodiment, the computer system 700 further includes an output device 725 (e.g., a display) to provide at least some of the results of the execution as output including, but not limited to, visual information to users and an input device 730 to provide a user or another device with means for entering data and/or otherwise interact with the computer system 700. Each of these output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the invention are described herein for illustrative purposes, various equivalent modifications are possible within the scope of the invention, as those skilled in the relevant art will recognize. These modifications can be made in light of the above detailed description. Rather, the scope is to be determined by the following claims, which are to be interpreted in accordance with established doctrines of claim construction.

1. An integrated project planning framework comprising:
a valuation options module to provide a plurality of planning value generation options, the valuation options module including:
a plurality of planning value generation modules to generate a plurality of planning values related to a plurality of organizational functions; and
a plan specific valuation module, including one or more of the plurality of planning value generation modules, to generate one or more planning values of a project; and
a valuation triggering module in communication with the valuation options module, the valuation triggering module identifying the plan specific valuation module to be executed for generating the one or more planning values of the project, the one or more planning value generation modules, included in the plan specific valuation module, being executed to generate the one or more planning values of the project.

2. The integrated project planning framework of claim 1, wherein the plurality of planning value generation modules includes:
a planning value generation logic to generate the one or more planning values based on a plurality of input data values, the plurality of input data values corresponding to one or more input parameters;
an input parameters map to map the one or more input data parameters to a plurality of input data sources storing the plurality of input data values; and
a plurality of output parameters to store the generated one or more planning values.

3. The integrated project planning framework of claim 2 further comprising:
a planning application in communication with the valuation triggering module, the planning application including:
one or more planning value fields to receive the generated one or more planning values stored in the plurality of output parameters, the planning application sending a valuation request to the valuation triggering module for generating the one or more planning values.

4. The integrated project planning framework of claim 3, wherein the plan specific valuation module further comprises:
an output parameters map to map the plurality of output parameters with the plurality of planning value fields in the planning application, the one or more planning value fields being populated with the planning values based on the output parameters map.

5. The integrated project planning framework of claim 1, further comprising:
a valuation module selection table to store a planning condition and the plan specific valuation module corresponding to the planning condition, the valuation triggering module identifying the plan specific valuation module, to be executed for generating the plan values, based on a planning condition of the project.

6. The integrated project planning framework of claim 1, wherein the plan specific valuation module further comprises:
an input data retrieval rule assigned to a planning value generation module, from the plurality of planning value generation modules, the input data retrieval rule defining a rule to retrieve input data values for the planning value generation module; and
an execution sequence module to store an execution sequence of the one or more planning value generation modules in the plan specific valuation module.

7. The integrated project planning framework of claim 1, wherein the plurality of planning value generation modules further includes:
a user defined planning value generation module including a user defined planning logic.

8. A computer implemented method for generating a plurality of planning values of a project, the method comprising:
at a planning application, receiving a valuation request to generate one or more of the plurality of planning values of the project related to a first organizational function and a remaining of the plurality of planning values of the project related to a second organizational function;
based on the received request, selecting, by a processor of the computer, a plan specific valuation module including a first planning valuation module to generate the one or more of the plurality of planning values related to the first organizational function and a second planning specific valuation module to generate the remaining of the plurality of planning values related to the second organizational function;
executing, by the processor of the computer, the first planning valuation generation module to generate the one or more of the plurality of planning values related to the first organizational function; and
executing, by the processor of the computer, the second planning valuation module to generate the remaining of the plurality of planning values related to the second organizational function.

9. The computer implemented method for claim 8, wherein selecting the plan specific valuation module further includes:
based on a planning condition of the project, searching, by the processor of the computer, a valuation module selection table to select the plan specific valuation module corresponding to the planning condition of the project.

10. The computer implemented method for claim 8, further comprising:
displaying the generated plurality of planning values in the planning application.

11. The computer implemented method of claim 10, wherein displaying the generated plurality of planning values further includes:
based on an output mapping, populating, by the processor of the computer, one or more of a plurality of planning value fields in the planning application with the determined plurality of planning values.

12. The computer implemented method of claim 8, further comprising:
receiving, by the processor of the computer, a user defined planning logic to generate a planning value, from the plurality of planning values, of the project; and
based on the received user defined planning logic, generating, by the processor of the computer, a user-defined planning data generation module including the user defined planning logic.

13. An article of manufacture including a computer readable storage medium to tangibly store instructions, which when executed by a computer, cause the computer to:
at a planning application, receive a valuation request to generate one or more of the plurality of planning values of the project related to a first organizational function and a remaining of the plurality of planning values of the project related to a second organizational function;
based on the received request, select a plan specific valuation module including a first planning valuation module to generate the one or more of the plurality of planning values related to the first organizational function and a second planning specific valuation module to generate the remaining of the plurality of planning values related to the second organizational function;
execute the first planning valuation generation module to generate the one or more of the plurality of planning values related to the first organizational function; and
execute the second planning valuation module to generate the remaining of the plurality of planning values related to the second organizational function.

14. The article of manufacture according to claim 13, further comprising instructions which when executed by the computer further causes the computer to:
based on a planning condition of the project, search a valuation module selection table to select the plan specific valuation module corresponding to the planning condition of the project.

15. The article of manufacture according to claim 13, further comprising instructions which when executed by the computer further causes the computer to:
display the generated plurality of planning values in the planning application.

16. The article of manufacture according to claim 15, further comprising instructions which when executed by the computer further causes the computer to:
based on a planning condition of the project, search a valuation module selection table to select the plan specific valuation module corresponding to the planning condition of the project.

17. A computer system for generating planning values of a project, the computer system comprising:
a memory to store a program code; and
a processor communicatively coupled to the memory, the processor configured to execute the program code to:
at a planning application, receive a valuation request to generate one or more of the plurality of planning values of the project related to a first organizational function and a remaining of the plurality of planning values of the project related to a second organizational function;
based on the received request, select a plan specific valuation module including a first planning valuation module to generate the one or more of the plurality of planning values related to the first organizational function and a second planning specific valuation module to generate the remaining of the plurality of planning values related to the second organizational function;
execute the first planning valuation generation module to generate the one or more of the plurality of planning values related to the first organizational function; and
execute the second planning valuation module to generate the remaining of the plurality of planning values related to the second organizational function.

18. The system of claim 17, wherein the processor further executes the program code to:
based on a planning condition of the project, search a valuation module selection table to select the plan specific valuation module corresponding to the planning condition of the project.

19. The system of claim 17, wherein the processor further executes the program code to:
display the generated plurality of planning values in the planning application.

20. The system of claim 19, wherein the processor further executes the program code to:
based on a planning condition of the project, search a valuation module selection table to select the plan specific valuation module corresponding to the planning condition of the project.
